(19) United States
(12) Patent Application Publication
(10) Pub. No.: US 2025/0130852 A1
(43) Pub. Date: Apr. 24, 2025

(54) APPARATUS AND METHOD OF WORKLOAD THROTTLING IN A MESH NETWORK

(71) Applicant: Ampere Computing LLC, Santa Clara, CA (US)

(72) Inventors: Benjamin Crawford CHAFFIN, Portland, OR (US); Raymond Scott TETRICK, Portland, OR (US)

(21) Appl. No.: 18/490,660

(22) Filed: Oct. 19, 2023

(51) Int. Cl. G06F 9/48

(52) U.S. Cl. CPC G06F 9/4881

(57) ABSTRACT

Disclosed are techniques for a request node device that is communicatively coupled to one or more completer devices via a mesh network. In an aspect, the request node device may receive multiple completer workload indicators, one after another, each one of the completer workload indicators indicating a level of activity of a corresponding completer device of the one or more completer devices. The request node devices may, for each one of the completer workload indicators received by the request node device, determine a current mapped workload value of a current completer workload indicator, update a current accumulation value based on the current mapped workload value and a previous accumulation value, and update a workload setting of the request node device for the workload throttling based on the current accumulation value.

### FIELD OF DISCLOSURE

This disclosure relates generally to a processing device including a mesh network connecting node devices. It relates more specifically, but not exclusively, to an apparatus and a method of workload throttling in the mesh network.

### BACKGROUND

A processing device (e.g., a processor) may include multiple components interconnected with one another via an interconnection network. In some examples, the components of a processing device may include processing cores, input/output interfaces, memory controllers, etc. However, as the number of components in a processing device increases (e.g., more processing cores in a single processor), communication and coordination among the components become more and more complicated. For example, the components may be connected with one another via an interconnection network inside the processing device. In some examples, the interconnection network may be a coherent mesh network. In some examples, a coherent mesh network may include a network of routing circuit blocks known as cross-points. In some examples, each component may be connected with a corresponding cross-point and may be referred to as a node device.

In some aspects, a component of the processing device (e.g., a request node device) may send one or more requests to a component of the processing device (e.g., a completer device). Also, the same completer device may receive requests from different request node devices. In some scenarios, a request node device sending more requests to a completer device that is already overwhelmed by outstanding requests directed to the completer device may cause a decrease in the overall processing efficiency of the processing device.

Accordingly, there is a need for apparatus and methods regarding workload throttling of the requests from a request node device to a completer device via an interconnection network of a processing device.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

In an aspect, a method of workload throttling by a request node device that is communicatively coupled to one or more completer devices via a mesh network includes receiving multiple completer workload indicators, one after another, by the request node device, each one of the completer workload indicators indicating a level of activity of a corresponding completer device of the one or more completer devices; and for each one of the completer workload indicators received by the request node device: determining a current mapped workload value of a current completer workload indicator; updating a current accumulation value based on the current mapped workload value and a previous accumulation value; and updating a workload setting of the request node device for the workload throttling based on the current accumulation value.

In an aspect, a processing device includes a request node device; one or more completer devices; and a mesh network, the request node device is communicatively coupled to the one or more completer devices via the mesh network, wherein the request node device comprises: interface circuitry communicatively coupled to the mesh network; and workload throttling circuitry configured to: receive multiple completer workload indicators, one after another via the interface circuitry, each one of the completer workload indicators indicating a level of activity of a corresponding completer device of the one or more completer devices; and for each one of the completer workload indicators received by the workload throttling circuitry of the request node device: determine a current mapped workload value of a current completer workload indicator; update a current accumulation value based on the current mapped workload value and a previous accumulation value; and update a workload setting of the request node device for the workload throttling based on the current accumulation value.

Other objects and advantages associated with the aspects disclosed herein will be apparent to those skilled in the art based on the accompanying drawings and detailed description.

### BRIEF DESCRIPTION OF THE DRAWINGS

A more complete appreciation of aspects of the disclosure and many of the attendant advantages thereof will be readily obtained as the same becomes better understood by reference to the following detailed description when considered in connection with the accompanying drawings which are presented solely for illustration and not limitation of the disclosure.

FIG. 1 is a block diagram of a processing device, according to aspects of the disclosure.

FIG. 2 is a block diagram of a request node device communicatively coupled to a mesh network, according to aspects of the disclosure.

FIG. 3 illustrates a first example processing flow of workload throttling, according to aspects of the disclosure.

FIG. 4 illustrates a second example processing flow of workload throttling, according to aspects of the disclosure.

FIG. 5 illustrates the workload throttling performed based on the first example processing flow shown in FIG. 3 and the workload throttling performed based on the second example processing flow shown in FIG. 4, according to aspects of the disclosure.

FIG. 6 illustrates an example method of workload throttling, according to aspects of the disclosure.

Other objects and advantages associated with the aspects disclosed herein will be apparent to those skilled in the art based on the accompanying drawings and detailed description. In accordance with common practice, the features depicted by the drawings may not be drawn to scale. Accordingly, the dimensions of the depicted features may be arbitrarily expanded or reduced for clarity. In accordance with common practice, some of the drawings are simplified for clarity. Thus, the drawings may not depict all components of a particular apparatus or method. Further, like reference numerals denote like features throughout the specification and figures.

### DETAILED DESCRIPTION

Aspects of the disclosure are provided in the description below and related drawings directed to various examples for illustration purposes. Alternate aspects may be devised without departing from the scope of the disclosure. Additionally, well-known elements of the disclosure will not be described in detail or will be omitted so as not to obscure the relevant details of the disclosure.

The words “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

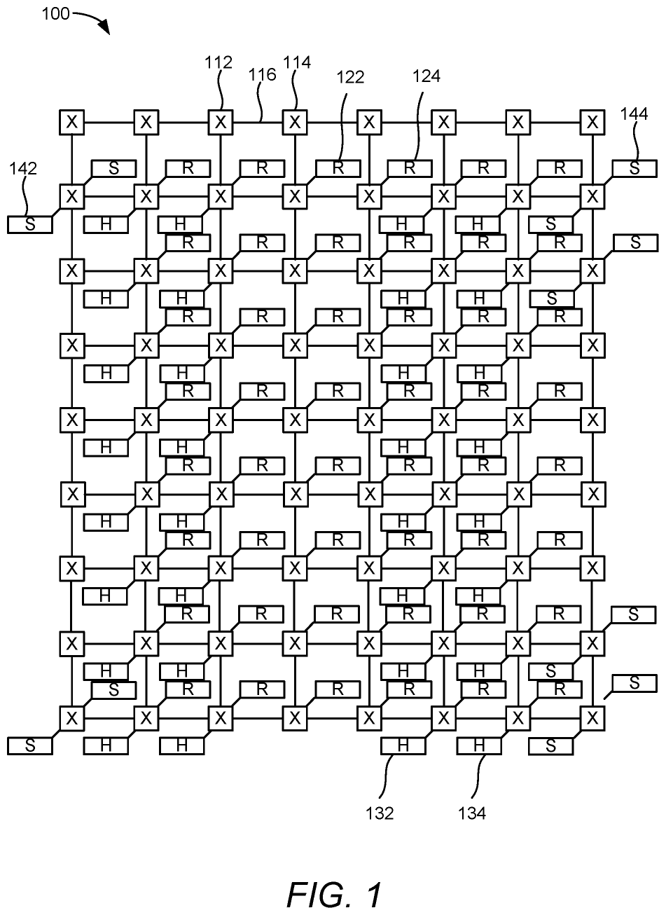

FIG. 1 is a block diagram of a processing device 100, according to aspects of the disclosure. In some aspects, the processing device 100 may be a processor formed based on an integrated circuit chip or multiple integrated circuit chips within an integrated circuit package. FIG. 1 is a simplified block diagram of the processing device 100, and various components of the processing device 100 may not be depicted in FIG. 1.

In some aspects, the processing device 100 may include a mesh network that is formed based on a plurality of routing circuit blocks (or also referred to as cross-points in this disclosure, and depicted in FIG. 1 as square boxes labeled ‘X’ such as blocks 112 and 114) interconnected with one another (depicted in FIG. 1 as solid lines connecting the cross-points such as line 116 connecting blocks 112 and 114). In some aspects, the processing device 100 may include node devices connected with one another via the mesh network. In some aspects, the processing device 100 may include request node devices (depicted in FIG. 1 as rectangular boxes labeled ‘R’ such as blocks 122 and 124), home node devices (depicted in FIG. 1 as rectangular boxes labeled ‘H’ such as blocks 132 and 134), slave node devices (depicted in FIG. 1 as rectangular boxes labeled ‘S’ such as blocks 142 and 144), and/or other types of node devices.

In some aspects, a slave node device may be coupled with a memory controller outside the processing device 100 and may be configured to receive a request to be executed by the memory controller regarding reading or writing data from or to a region of a memory. In some aspects, a request node device may be configured to transmit a request to a slave node device in order to read or write the data from or to the region of the memory. In some aspects, a home node device may be associated with the region of the memory and configured to accept requests from various request node devices and redirect the requests to proper slave node devices.

In some aspects, a request node device may be a processing core that is configured to execute an instruction of a program. In some aspects, a home node device or a slave node device may be a state machine or a combinational logic circuit block that is configured to handle a set of logic state transitions but not configured to execute an instruction of a program.

In some aspects, each one of the cross-points may be assigned with a corresponding cross-point identifier (XP ID). In some aspects, each one of the request node devices, the home node devices, and the slave node devices connected to the mesh network may be assigned with a corresponding node identifier (NID). In some aspects, a request node device may determine a receiving home node device of a request by looking up the NID of the receiving home node device from a first system address map based on an address associated with the request. In some aspects, a home node device may determine a receiving slave node device of a request by looking up the NID of the receiving slave node device from a second system address map based on the address associated with the request. In some aspects, the request may be prepared based on a mesh network communication protocol, such as an Advanced Microcontroller Bus Architecture (AMBA) Coherent Hub Interface (CHI) protocol.

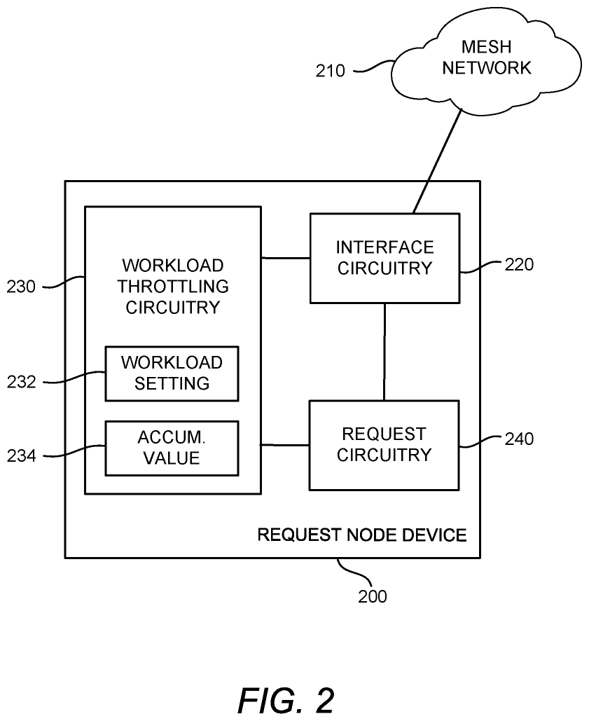

FIG. 2 is a block diagram of a request node device 200 communicatively coupled to a mesh network 210, according to aspects of the disclosure. In some aspects, the request node device 200 may correspond to a request node device of the processing device 100 shown in FIG. 1. FIG. 2 is a simplified block diagram of the request node device 200, and other details of the request node device 200 may not be depicted in FIG. 2.

As shown in FIG. 2, the request node device 200 may include interface circuitry 220, workload throttling circuitry 230, and request circuitry 240. In some aspects, the interface circuitry 220 may be communicatively coupled to the mesh network 210. In some aspects, the workload throttling circuitry 230 may receive completer workload indicators (e.g., completer busy (CBUSY) indicators based on the AMBA CHI protocol) from other components of the processing device 100 via the interface circuitry 220 and the mesh network 210. In some aspects, the request circuitry 240 may send requests directed to other components of the processing device 100 via the interface circuitry 220 and the mesh network 210.

In some aspects, the workload throttling circuitry 230 may be configured to receive multiple completer workload indicators, one after another via the interface circuitry 220. In some aspects, each one of the completer workload indicators may indicate a level of activity of a corresponding completer device of one or more completer devices communicatively coupled with to the mesh network 210. In some aspects, a completer device may be a slave node device of the processing device 100 and communicatively coupled to the mesh network 210. In some aspects, a completer device may be a circuitry component of the processing device 100 and directly, or indirectly via a slave node device, coupled to the mesh network 210.

In some aspects, the workload throttling circuitry 230 of the request node device 200 may update the workload setting 232 of the request node device 200 based on the completer workload indicators received by the workload throttling circuitry 230 of the request node device 200. In some aspects, the workload setting may include a non-type-specific rate of outgoing requests for all types of requests, a type-specific rate of outgoing requests for a specific type of requests, enable or disable of prefetch functionality, a quality of service level (e.g., for setting the priority of the outgoing requests), or a combination thereof. In some aspects, various types of requests may include a read type request (or simply “a read request”) or a write type request (or simply “a write request”).

In some aspects, the request circuitry 240 may be configured to send requests to other components of the processing device 100 based on the workload setting 232. In some aspects, the request circuitry 240 may adjust a rate of outgoing requests and/or adjust a priority setting of the outgoing requests based on the workload setting 232, other information collected based on the received completer workload indicators, and/or information regarding currently outstanding requests.

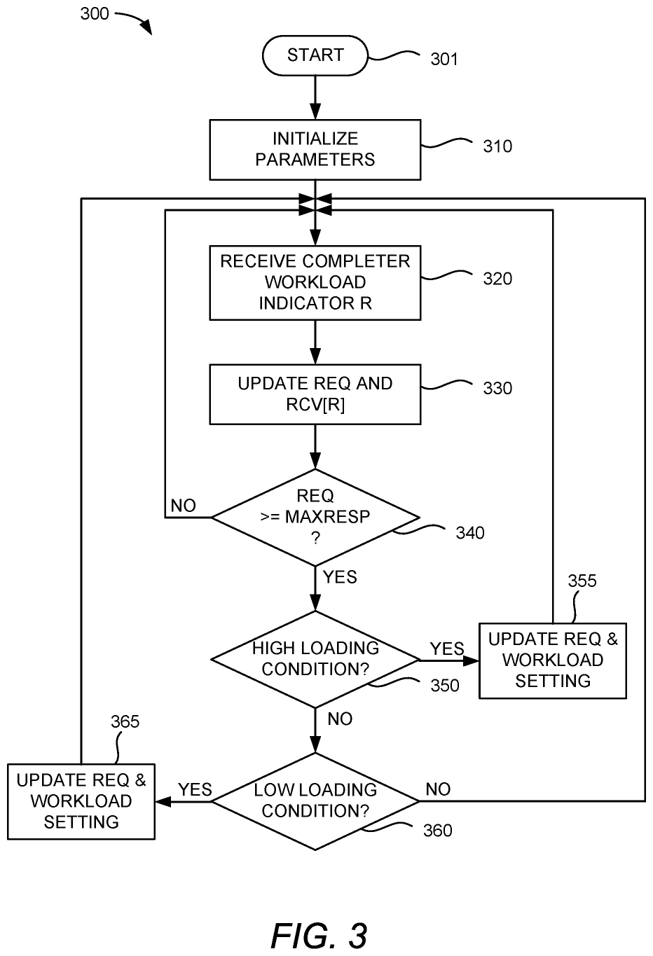

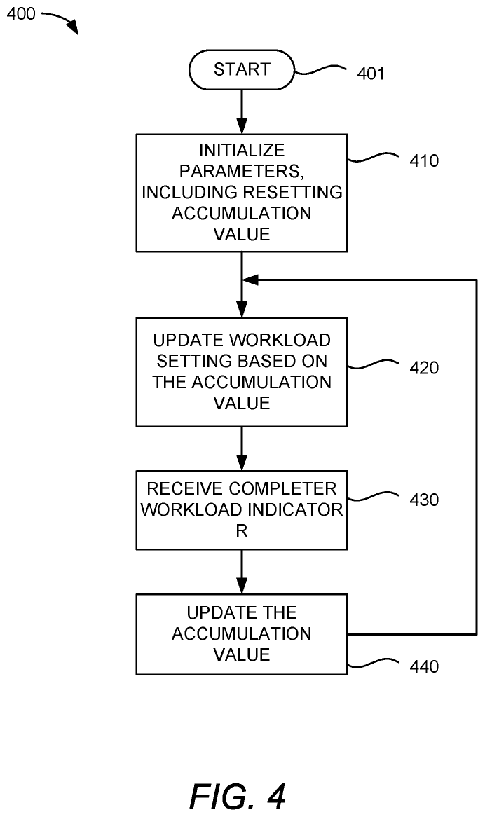

In some aspects, the processing device 100 may be a processing device based on an ARM® CHI Revision D (“ARM CHI-D”) architecture. In some aspects, a completer device of the processing device 100 based on ARM CHI-D architecture may use completer workload indicators (e.g., CBUSY indicators) as a feedback mechanism to inform the request node devices of the processing device 100 about the workload status of the completer device (e.g., the oversubscription of resources). In some aspects, there may be different approaches regarding how a request node device may respond to the completer workload indicators. In some examples, the workload throttling circuitry 230 may update the workload setting 232 for workload throttling once every triggering period or once every triggering number of received completer workload indicators, based on fixed size addition or subtraction to the number of outstanding requests without using the accumulation value 234. In some aspects, how the workload throttling circuitry 230 may perform the workload throttling without using the accumulation value 234 may be further illustrated with reference to FIG. 3. In some other examples, the workload throttling circuitry 230 may, every time a completer workload indicator is received, update an accumulation value 234 (labeled as “ACCUM. VALUE” in FIG. 2) and update the workload setting 232 of the request node device 200 for the workload throttling based on the updated accumulation value 234. In some aspects, how the accumulation value 234 may be updated and used for workload throttling may be further illustrated with reference to FIG. 4.

FIG. 3 illustrates a first example processing flow 300 of workload throttling, according to aspects of the disclosure. In some aspects, the processing flow 300 may be performed by the request node device 200 shown in FIG. 2, without using the accumulation value 234.

In some aspects, the processing flow 300 may start at 301 and proceed to stage 310, where the request node device 200 may initialize various parameters. In some aspects, stage 310 may include loading or setting various minimum or maximum values. In some aspects, stage 310 may include setting a total indicator count REQ to zero and setting individual indicator counts RCV [0-3] for each possible label of the completer workload indicator to zero (assuming a completer workload indicator may have labels of 0, 1, 2, or 3 in this non-limiting example).

At stage 320, the request node device 200 may receive a completer workload indicator indicating a label R, where R may be 0, 1, 2, or 3. In some aspects, the completer workload indicator may indicate a lowest activity level using the label 0, a lower activity level using the label 1, a higher activity level using the label 2, and a highest activity level using the label 3. At stage 330, the request node device 200 may increase the total indicator count REQ by one in response to the completer workload indicator received at stage 320. Also, at stage 330, the request node device 200 may increase the individual indicator count parameters RCV [R] by one.

At stage 340, the request node device 200 may determine if the total indicator count REQ has reaches a maximum indicator number MAXRESP. If the total indicator count REQ is determined as reaching the maximum indicator number MAXRESP (i.e., >=MAXRESP), the processing flow 300 proceeds to stage 350 (e.g., the YES branch). If the total indicator count REQ is determined as not reaching the maximum indicator number MAXRESP, the processing flow 300 proceeds to stage 320 (e.g., the NO branch).

At stage 350, the request node device 200 may determine if a high loading condition is met based on a portion or all of the individual indicator counts RCV [0-3]. In some aspects, as a non-limiting example, the high loading condition may correspond to RCV [3] equal to or greater than a high loading threshold. If the high loading condition is determined as met, the processing flow 300 proceeds to stage 355 (e.g., the YES branch). If the high loading condition is determined as not met, the processing flow 300 proceeds to stage 360 (e.g., the NO branch).

At stage 355, the request node device 200 may update the total indicator count REQ to a first base value or zero, and may update the workload setting that may lead to decrease of the activity level of the completer device (e.g., by disabling the prefetching functionality of the request node device). After stage 355, the processing flow 300 may proceed to stage 320.

At stage 360, the request node device 200 may determine if a low loading condition is met based on a portion or all of the individual indicator counts RCV [0-3]. In some aspects, as a non-limiting example, the low loading condition may correspond to a summation of RCV [0] and RCV [1] equal to or greater than a low loading threshold. If the low loading condition is determined as met, the processing flow 300 proceeds to stage 365 (e.g., the YES branch). If the low loading condition is determined as not met, the processing flow 300 proceeds to stage 320 (e.g., the NO branch).

At stage 365, the request node device 200 may update the total indicator count REQ to a second base value or zero, and may update the workload setting that may lead to increase of the activity level of the completer device (e.g., by enabling the prefetching functionality of the request node device). After stage 365, the processing flow 300 may proceed to stage 320.

FIG. 4 illustrates a second example processing flow 400 of workload throttling, according to aspects of the disclosure. In some aspects, the processing flow 400 may be performed by the request node device 200 shown in FIG. 2, based on using the accumulation value 234.

In some aspects, the processing flow 400 may start at 401 and proceed to stage 410, where the request node device 200 may initialize various parameters. In some aspects, stage 410 may include loading or setting various tables for determining the accumulation value 234 and for determining the corresponding workload settings in association with different accumulation values 234. In some aspects, stage 310 may include resetting the accumulation value 234 to zero.

At stage 420, the request node device 200 may set or update the workload setting 232 based on the accumulation value 234. In some aspects, the workload setting may include a non-type-specific rate of outgoing requests for all types of requests, a type-specific rate of outgoing requests for a specific type of requests, enable or disable of prefetch functionality, a quality of service level, or a combination thereof. In some aspects, the request node device 200 may determine the workload setting applicable to requests directed to a single completer device based on completer workload indicators received from the single completer device. In some aspects, the request node device 200 may determine the workload setting applicable to requests directed to a plurality of completer devices based on completer workload indicators received from the plurality of completer devices.

In some aspects, the workload setting may be updated based on the current accumulation value and a first table. In some aspects, TABLE I shows an example of the first table.

TABLE I

| | Rate of | Enable/Disable | Quality of |
|---|---|---|---|
| Index | Requests | of Prefetch | Service Level |
| 0 | R[0] | P[0] | Q[0] |
| 1 | R[1] | P[1] | Q[1] |
| 2 | R[2] | P[2] | Q[2] |
| 3 | R[3] | P[3] | Q[3] |
| 4 | R[4] | P[4] | Q[4] |
| 5 | R[5] | P[5] | Q[5] |
| 6 | R[6] | P[6] | Q[6] |
| 7 | R[7] | P[7] | Q[7] |
| 8 | R[8] | P[8] | Q[8] |
| 9 | R[9] | P[9] | Q[9] |
| 10 | R[10] | P[10] | Q[10] |
| 11 | R[11] | P[11] | Q[11] |
| 12 | R[12] | P[12] | Q[12] |
| 13 | R[13] | P[13] | Q[13] |
| 14 | R[14] | P[14] | Q[14] |
| 15 | R[15] | P[15] | Q[15] |

In some aspects, as shown in TABLE I, the first table may include 16 entries that are indexed based on the most significant four bits of the accumulation value 234. In some aspects, each one of R [0:15] may indicate a corresponding rate of outgoing requests (may be a non-type-specific or a type-specific, depending on the implementation). In some aspects, each one of P [0:15] may indicate a corresponding enable or disable of prefetch functionality. In some aspects, each one of Q [0:15] may indicate a corresponding quality of service level.

In some aspects, the first table may be programmable. Accordingly, based on configuring the first table differently, the processing device 100 may be configured to respond to completer workload indicators more or less aggressively.

At stage 430, the request node device 200 may receive a completer workload indicator indicating a label R, where R may be 0, 1, 2, or 3 in this example. In some aspects, the completer workload indicator may indicate a lowest activity level using the label 0, a lower activity level using the label 1, a higher activity level using the label 2, and a highest activity level using the label 3.

At stage 440, the request node device 200 may update the accumulation value based on the completer workload indicator received at stage 430. In some aspects, stage 440 may include first determining a current mapped workload value of a current completer workload indicator, and then updating the accumulation value to a current accumulation value based on the current mapped workload value and a previous accumulation value. In some aspects, the accumulation value may be determined based on a summation of the current mapped workload value and the previous accumulation value. In some aspects, the accumulation value may be trimmed to be no greater than a maximum value and no less than a minimum value. In some aspects, the maximum value may be set to 1023, and the minimum value may be set to zero.

In some aspects, the current mapped workload value of the current completer workload indicator may be determined based on a second table. In some aspects, TABLE II shows an example of the second table.

TABLE II

| CBUSY INDICATOR | CBUSY VALUE |
|---|---|
| 0 | V[0] |
| 1 | V[1] |
| 2 | V[2] |
| 3 | V[3] |

In some aspects, each completer workload indicator label may be mapped to a different mapped workload value that is to be accumulated in the accumulation value. In some aspects, as shown in TABLE II, each one of V [0:3] may indicate a mapped workload value for a corresponding completer workload indicator label. In some aspects, the second table may be programmable. Accordingly, based on configuring the second table differently, the processing device 100 may be configured to respond to completer workload indicators more or less aggressively.

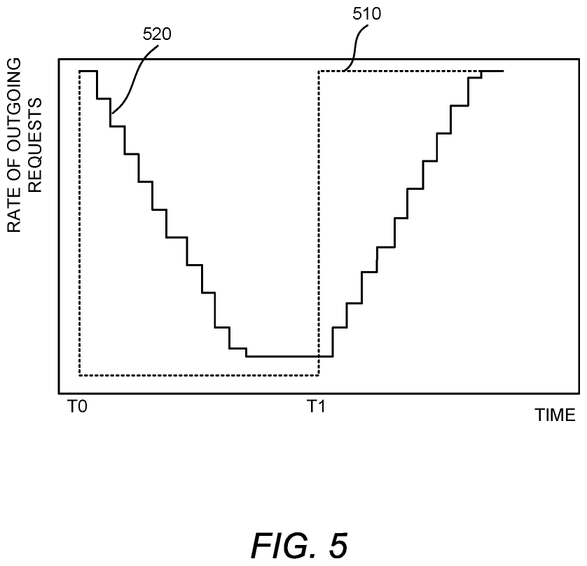

FIG. 5 illustrates the workload throttling performed based on the first example processing flow 300 shown in FIG. 3 and the workload throttling performed based on the second example processing flow 400 shown in FIG. 4, according to aspects of the disclosure. In FIG. 5, the horizontal axis represents time, and the vertical axis represents the rate of outgoing requests as an example of the workload setting adjusted according to the processing flows shown in FIGS. 3 and 4. In FIG. 5, line segments 510 correspond to the results of the processing flow 300 in FIG. 3, and line segments 520 correspond to the results of the processing flow 400 in FIG. 4. In some aspects, the example processing flow 300 shown in FIG. 3 may correspond to the workload throttling circuitry 230 updating the workload setting 232 without using the accumulation value 234; and the example processing flow 400 shown in FIG. 4 may correspond to the workload throttling circuitry 230 updating the workload setting 232 based on the accumulation value 234.

As illustrated by the line segments 510, the workload throttling performed based on the processing flow 300 may adjust the workload setting at time TO when the total indicator count REQ reaches the maximum indicator number MAXRESP (e.g., reaching stage 340 in FIG. 3), reset the total indicator count REQ at time TO (e.g., stage 355 or stage 365 in FIG. 3)), and adjust the workload setting again at time Tl when the total indicator count REQ once again reaches the maximum indicator number MAXRESP (e.g., reaching stage 340 in FIG. 3 again after state 355 or stage 365). In contrast, as illustrated by the line segments 520, the workload throttling performed based on the processing flow 400 may adjust the workload setting every time a complete workload indicator is received (e.g., every time reaching stage 430 in FIG. 4, stage 440 may be performed).

Accordingly, the processing flow 400 may allow a more rapid response time to the change of the activity level of the corresponding completer device. In some aspects, the quick response to oversubscription of resources may be key to high performance and responsiveness of a processing device. In some aspects, as the accumulation value may be determined based on accumulating the mapped workload indicator values of a series of completer workload indicators, the processing flow 400 may better respond to a trend of the activity level of the corresponding completer device and smoothen the impact of a transient change in the activity level of the corresponding completer device. In some aspects, as the accumulation value is still updated every time a new completer workload indicator is received, the processing flow 400 may still respond to the change of the activity level quicker than the processing flow 300, and can reflect the change of the activity level in as few as 16 update cycles (e.g., based on receiving 16 completer workload indicators).

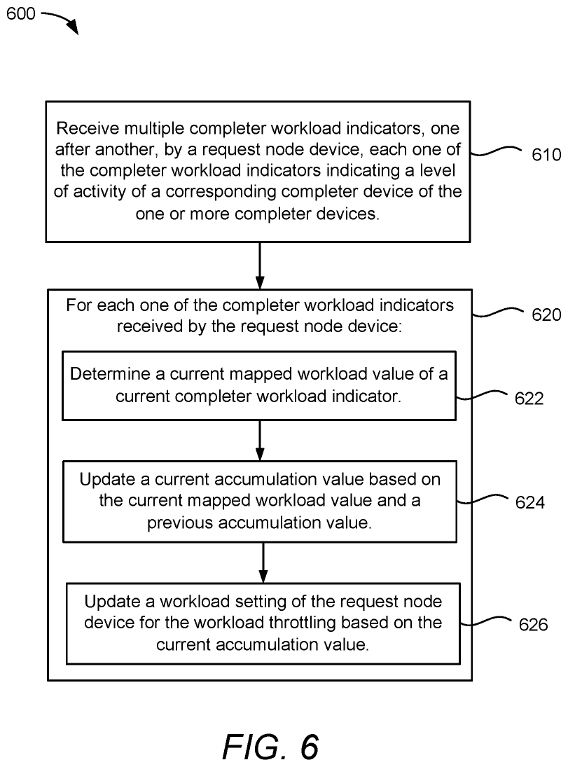

FIG. 6 illustrates an example method 600 of workload throttling, according to aspects of the disclosure. In some aspects, the method 600 may be performed by the request node device 200 shown in FIG. 2. In some aspects, the request node device 200 that is configured to perform the method 600 may be communicatively coupled to one or more completer devices via a mesh network, such as the mesh network shown in FIG. 1. In some aspects, the method 600 may be performed based on the examples illustrated in FIG. 4.

At operation 610, the request node device 200 can receive multiple completer workload indicators, one after another. In some aspects, each one of the completer workload indicators may indicate a level of activity of a corresponding completer device of the one or more completer devices.

At operation 620, a series of operations may be performed for each one of the completer workload indicators received by the request node device 200. In some aspects, operation 620 may include operation 622, where a current mapped workload value of a current completer workload indicator may be determined. In some aspects, operation 620 may include operation 624, where a current accumulation value may be updated based on the current mapped workload value and a previous accumulation value. In some aspects, operation 620 may include operation 626, where a workload setting of the request node device for the workload throttling may be updated based on the current accumulation value.

In some aspects, the workload setting may include a non-type-specific rate of outgoing requests for all types of requests, a type-specific rate of outgoing requests for a specific type of requests, enable or disable of prefetch functionality, a quality of service level, or a combination thereof. In some aspects, the one or more completer devices may include a single completer device, and the workload setting may be applicable to requests directed to the single completer device. In some aspects, the one or more completer devices includes a plurality of completer devices, and the workload setting may be applicable to requests directed to any one of the plurality of completer devices.

In some aspects, the workload setting may be updated based on the current accumulation value and a first table. In some aspects, the first table may be programmable. In some aspects, the first table may include 16 entries that are indexed based on the most significant four bits of the accumulation value.

In some aspects, the current mapped workload value of the current completer workload indicator may be determined based on a second table. In some aspects, the second table may be programmable. In some aspects, the accumulation value may be determined based on a summation of the current mapped workload value and the previous accumulation value.

In some aspects, the method 600 may further includes, for each one of the completer workload indicators received by the request node device, determining whether more than half of outstanding requests directed to the corresponding completer device are from the request node device, and lowering a priority setting of one or more subsequent write requests directed to the corresponding completer device, one or more subsequent read requests directed to the corresponding completer device, or a combination thereof, based on a determination that more than half of the outstanding requests directed to the corresponding completer device are from the request node device.

As will be appreciated, a technical advantage of the method 600 is updating the workload setting of a request node device based on a running accumulation value every time a new completer workload indicator is received. Accordingly, the workload setting of a request node device may be updated to quickly respond to the change of activity level of a completer device in order to improve the processing efficiency, while the workload setting is still updated based on a trend of the activity level in order to smoothen the impact of a transient change in the activity level.

Those of skill in the art will appreciate that the information and signals described above may be represented using any of a variety of different technologies and techniques. For example, data, instructions, commands, information, signals, bits, symbols, and chips that may be referenced throughout the description above may be represented by voltages, currents, electromagnetic waves, magnetic fields or particles, optical fields or particles, or any combination thereof, depending in part on the particular application, in part on the desired design, in part on the corresponding technology, etc.

Further, many aspects are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, the sequence(s) of actions described herein can be considered to be embodied entirely within any form of non-transitory computer-readable storage medium having stored therein a corresponding set of computer instructions that, upon execution, would cause or instruct an associated processor of a device to perform the functionality described herein. Thus, the various aspects of the disclosure may be embodied in a number of different forms, all of which have been contemplated to be within the scope of the claimed subject matter. In addition, for each of the aspects described herein, the corresponding form of any such aspects may be described herein as, for example, “logic configured to” perform the described action.

In the detailed description above it can be seen that different features are grouped together in examples. This manner of disclosure should not be understood as an intention that the example clauses have more features than are explicitly mentioned in each clause. Rather, the various aspects of the disclosure may include fewer than all features of an individual example clause disclosed. Therefore, the following clauses should hereby be deemed to be incorporated in the description, wherein each clause by itself can stand as a separate example. Although each dependent clause can refer in the clauses to a specific combination with one of the other clauses, the aspect(s) of that dependent clause are not limited to the specific combination. It will be appreciated that other example clauses can also include a combination of the dependent clause aspect(s) with the subject matter of any other dependent clause or independent clause or a combination of any feature with other dependent and independent clauses. The various aspects disclosed herein expressly include these combinations, unless it is explicitly expressed or can be readily inferred that a specific combination is not intended (e.g., contradictory aspects, such as defining an element as both an electrical insulator and an electrical conductor). Furthermore, it is also intended that aspects of a clause can be included in any other independent clause, even if the clause is not directly dependent on the independent clause.

Implementation examples are described in the following numbered clauses:

Clause 1. A method of workload throttling by a request node device that is communicatively coupled to one or more completer devices via a mesh network, the method comprising: receiving multiple completer workload indicators, one after another, by the request node device, each one of the completer workload indicators indicating a level of activity of a corresponding completer device of the one or more completer devices; and for each one of the completer workload indicators received by the request node device: determining a current mapped workload value of a current completer workload indicator; updating a current accumulation value based on the current mapped workload value and a previous accumulation value; and updating a workload setting of the request node device for the workload throttling based on the current accumulation value.

Clause 2. The method of clause 1, wherein the workload setting includes: a non-type-specific rate of outgoing requests for all types of requests, a type-specific rate of outgoing requests for a specific type of requests, enable or disable of prefetch functionality, a quality of service level, or a combination thereof.

Clause 3. The method of any of clauses 1 to 2, wherein: the one or more completer devices includes a single completer device, and the workload setting is applicable to requests directed to the single completer device.

Clause 4. The method of any of clauses 1 to 2, wherein: the one or more completer devices includes a plurality of completer devices, and the workload setting is applicable to requests directed to any one of the plurality of completer devices.

Clause 5. The method of any of clauses 1 to 4, wherein the updating the workload setting based on the current accumulation value is based on a first table.

Clause 6. The method of clause 5, wherein the first table is programmable.

Clause 7. The method of any of clauses 5 to 6, wherein the first table includes 16 entries that are indexed based on the most significant four bits of the accumulation value.

Clause 8. The method of any of clauses 1 to 7, wherein the determining the current mapped workload value of the current completer workload indicator is based on a second table.

Clause 9. The method of clause 8, wherein the second table is programmable.

Clause 10. The method of any of clauses 1 to 9, wherein the determining the accumulation value is based on a summation of the current mapped workload value and the previous accumulation value.

Clause 11. The method of any of clauses 1 to 10, further comprising, for each one of the completer workload indicators received by the request node device: determining whether more than half of outstanding requests directed to the corresponding completer device are from the request node device; and lowering a priority setting of one or more subsequent write requests directed to the corresponding completer device, one or more subsequent read requests directed to the corresponding completer device, or a combination thereof, based on a determination that more than half of the outstanding requests directed to the corresponding completer device are from the request node device.

Clause 12. A processing device, comprising: a request node device; one or more completer devices; and a mesh network, the request node device is communicatively coupled to the one or more completer devices via the mesh network, wherein the request node device comprises: interface circuitry communicatively coupled to the mesh network; and workload throttling circuitry configured to: receive multiple completer workload indicators, one after another via the interface circuitry, each one of the completer workload indicators indicating a level of activity of a corresponding completer device of the one or more completer devices; and for each one of the completer workload indicators received by the workload throttling circuitry of the request node device: determine a current mapped workload value of a current completer workload indicator; update a current accumulation value based on the current mapped workload value and a previous accumulation value; and update a workload setting of the request node device for the workload throttling based on the current accumulation value.

Clause 13. The processing device of clause 12, wherein the workload setting includes: a non-type-specific rate of outgoing requests for all types of requests, a type-specific rate of outgoing requests for a specific type of requests, enable or disable of prefetch functionality, a quality of service level, or a combination thereof.

Clause 14. The processing device of any of clauses 12 to 13, wherein: the one or more completer devices includes a single completer device, and the workload setting is applicable to requests directed to the single completer device.

Clause 15. The processing device of any of clauses 12 to 13, wherein: the one or more completer devices includes a plurality of completer devices, and the workload setting is applicable to requests directed to any one of the plurality of completer devices.

Clause 16. The processing device of any of clauses 12 to 15, wherein the workload setting is updated based on a first table.

Clause 17. The processing device of clause 16, wherein the first table is programmable.

Clause 18. The processing device of any of clauses 16 to 17, wherein the first table includes 16 entries that are indexed based on the most significant four bits of the accumulation value.

Clause 19. The processing device of any of clauses 12 to 18, wherein the current mapped workload value is determined based on a second table.

Clause 20. The processing device of clause 19, wherein the second table is programmable.

Clause 21. The processing device of any of clauses 12 to 20, wherein the accumulation value is determined based on a summation of the current mapped workload value and the previous accumulation value.

Clause 22. The processing device of any of clauses 12 to 21, further comprising: request circuitry configured to, for each one of the completer workload indicators received by the request node device: determine whether more than half of outstanding requests directed to the corresponding completer device are from the request node device; and lower a priority setting of at least one or more subsequent write requests directed to the corresponding completer device, one or more subsequent read requests directed to the corresponding completer device, or a combination thereof, based on a determination that more than half of the outstanding requests directed to the corresponding completer device are from the request node device.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a general purpose processor, a DSP, an ASIC, an FPGA, or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The methods, sequences and/or algorithms described in connection with the aspects disclosed herein may be embodied directly in hardware, in a software module executed by a processor, or in a combination of the two. A software module may reside in random access memory (RAM), flash memory, read-only memory (ROM), erasable programmable ROM (EPROM), electrically erasable programmable ROM (EEPROM), registers, hard disk, a removable disk, a CD-ROM, or any other form of storage medium known in the art. An example storage medium is coupled to the processor such that the processor can read information from, and write information to, the storage medium. In the alternative, the storage medium may be integral to the processor. The processor and the storage medium may reside in an ASIC. The ASIC may reside in a user terminal (e.g., UE). In the alternative, the processor and the storage medium may reside as discrete components in a user terminal.

In one or more example aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

While the foregoing disclosure shows illustrative aspects of the disclosure, it should be noted that various changes and modifications could be made herein without departing from the scope of the disclosure as defined by the appended claims. For example, the functions, steps and/or actions of the method claims in accordance with the aspects of the disclosure described herein need not be performed in any particular order. Further, no component, function, action, or instruction described or claimed herein should be construed as critical or essential unless explicitly described as such. Furthermore, as used herein, the terms “set,” “group,” and the like are intended to include one or more of the stated elements. Also, as used herein, the terms “has,” “have,” “having,” “comprises,” “comprising,” “includes,” “including,” and the like does not preclude the presence of one or more additional elements (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”) or the alternatives are mutually exclusive (e.g., “one or more” should not be interpreted as “one and more”). Furthermore, although components, functions, actions, and instructions may be described or claimed in the singular, the plural is contemplated unless limitation to the singular is explicitly stated. Accordingly, as used herein, the articles “a,” “an,” “the,” and “said” are intended to include one or more of the stated elements. Additionally, as used herein, the terms “at least one” and “one or more” encompass “one” component, function, action, or instruction performing or capable of performing a described or claimed functionality and also “two or more” components, functions, actions, or instructions performing or capable of performing a described or claimed functionality in combination.

What is claimed is:

1. A method of workload throttling by a request node device that is communicatively coupled to one or more completer devices via a mesh network, the method comprising:
receiving multiple completer workload indicators, one after another, by the request node device, each one of the completer workload indicators indicating a level of activity of a corresponding completer device of the one or more completer devices; and
for each one of the completer workload indicators received by the request node device:
determining a current mapped workload value of a current completer workload indicator;
updating a current accumulation value based on the current mapped workload value and a previous accumulation value; and
updating a workload setting of the request node device for the workload throttling based on the current accumulation value.

2. The method of claim 1, wherein the workload setting includes:
a non-type-specific rate of outgoing requests for all types of requests,
a type-specific rate of outgoing requests for a specific type of requests,
enable or disable of prefetch functionality,
a quality of service level, or
a combination thereof.

3. The method of claim 1, wherein:
the one or more completer devices includes a single completer device, and
the workload setting is applicable to requests directed to the single completer device.

4. The method of claim 1, wherein:
the one or more completer devices includes a plurality of completer devices, and
the workload setting is applicable to requests directed to any one of the plurality of completer devices.

5. The method of claim 1, wherein the updating the workload setting based on the current accumulation value is based on a first table.

6. The method of claim 5, wherein the first table is programmable.

7. The method of claim 5, wherein the first table includes 16 entries that are indexed based on the most significant four bits of the accumulation value.

8. The method of claim 1, wherein the determining the current mapped workload value of the current completer workload indicator is based on a second table.

9. The method of claim 8, wherein the second table is programmable.

10. The method of claim 1, wherein the determining the accumulation value is based on a summation of the current mapped workload value and the previous accumulation value.

11. The method of claim 1, further comprising, for each one of the completer workload indicators received by the request node device:
determining whether more than half of outstanding requests directed to the corresponding completer device are from the request node device; and
lowering a priority setting of one or more subsequent write requests directed to the corresponding completer device, one or more subsequent read requests directed to the corresponding completer device, or a combination thereof, based on a determination that more than half of the outstanding requests directed to the corresponding completer device are from the request node device.

12. A processing device, comprising:
a request node device;
one or more completer devices; and
a mesh network, the request node device is communicatively coupled to the one or more completer devices via the mesh network,
wherein the request node device comprises:
interface circuitry communicatively coupled to the mesh network; and
workload throttling circuitry configured to:
receive multiple completer workload indicators, one after another via the interface circuitry, each one of the completer workload indicators indicating a level of activity of a corresponding completer device of the one or more completer devices; and
for each one of the completer workload indicators received by the workload throttling circuitry of the request node device:
determine a current mapped workload value of a current completer workload indicator;
update a current accumulation value based on the current mapped workload value and a previous accumulation value; and
update a workload setting of the request node device for the workload throttling based on the current accumulation value.

13. The processing device of claim 12, wherein the workload setting includes:
a non-type-specific rate of outgoing requests for all types of requests,
a type-specific rate of outgoing requests for a specific type of requests,
enable or disable of prefetch functionality,
a quality of service level, or
a combination thereof.

14. The processing device of claim 12, wherein:
the one or more completer devices includes a single completer device, and
the workload setting is applicable to requests directed to the single completer device.

15. The processing device of claim 12, wherein:
the one or more completer devices includes a plurality of completer devices, and
the workload setting is applicable to requests directed to any one of the plurality of completer devices.

16. The processing device of claim 12, wherein the workload setting is updated based on a first table.

17. The processing device of claim 16, wherein the first table is programmable.

18. The processing device of claim 16, wherein the first table includes 16 entries that are indexed based on the most significant four bits of the accumulation value.

19. The processing device of claim 12, wherein the current mapped workload value is determined based on a second table.

20. The processing device of claim 19, wherein the second table is programmable.

21. The processing device of claim 12, wherein the accumulation value is determined based on a summation of the current mapped workload value and the previous accumulation value.

22. The processing device of claim 12, further comprising:
request circuitry configured to, for each one of the completer workload indicators received by the request node device:
determine whether more than half of outstanding requests directed to the corresponding completer device are from the request node device; and
lower a priority setting of at least one or more subsequent write requests directed to the corresponding completer device, one or more subsequent read requests directed to the corresponding completer device, or a combination thereof, based on a determination that more than half of the outstanding requests directed to the corresponding completer device are from the request node device.
